(19) United States
(12) Patent Application Publication
(10) Pub. No.: US 2017/0213236 A1
(43) Pub. Date: Jul. 27, 2017

(54) Estimation of Causal Impact of Digital Marketing Content

(71) Applicant: Adobe Systems Incorporated, San Jose, CA (US)

(72) Inventors: Moumita Sinha, Kolkata (IN); Abhimanyu Jain Asati, Jabalpur (IN); Mihir Sudhir Kulkarni, Thane (West) (IN); Pankaj Gudlani, Jaipur (IN); Atanu R. Sinha, Boulder, CO (US)

(21) Appl. No.: 15/008,181

(22) Filed: Jan. 27, 2016

(51) Int. Cl. G06Q 30/02

(52) U.S. Cl. CPC G06Q 30/0243; G06Q 30/0246

(57) ABSTRACT

A digital medium environment is described to estimate a resulting causal impact of a particular item of digital marketing content on a digital marketing outcome. A first sequence is identified of a plurality of items of digital marketing content provided to a first set of users taken from a plurality of users. the first sequence includes the particular item. A second sequence is constructed of the plurality of items of the digital marketing content by removing the particular item from the first sequence. A second set is identified of users from the plurality of users provided with the second sequence. The resulting causal impact is estimated of the particular item of digital marketing content on the digital marketing outcome based on first and second causal impacts for subsets of the first and second sets.

### BACKGROUND

Digital marketing content is typically provided to users in order to increase a likelihood that a user will interact with the content or another item of digital marketing content toward purchase of a product or service, which is also referred to as conversion. In one example of use of digital marketing content and conversion, a user may navigate through webpages of a website of a service provider. During this navigation, the user is exposed to advertisements relating to the good or service. If the advertisements are of interest to the user, the user may select the advertisement to navigate to webpages that contain more information about the product or service that is a subject of the advertisement, functionality usable to purchase the good or service, and so forth. Each of these selections thus involves conversion of interaction of the user with respective digital marketing content into other interactions with other digital marketing content and/or even purchase of the good or service. Thus, configuration of the advertisements in a manner that is likely to be of interest to the users increases the likelihood of conversion of the users regarding the product or service.

In another example of digital marketing content and conversion, users may agree to receive emails or other electronic messages relating to goods or services provided by the service provider. The user, for instance, may opt-in to receive emails of marketing campaigns corresponding to a particular brand of product or service. Likewise, success in conversion of the users towards the product or service that is a subject of the emails directly depends on interaction of the users with the emails. Since this interaction is closely tied to a level of interest the user has with the emails, configuration of the emails also increases the likelihood of conversion of the users regarding the product or service.

Conventional techniques that are used to determine a causal impact of the digital marketing content on conversion of the product or service, however, focus on individual items of the digital marketing content. Consequently, these conventional techniques cannot address instances in which a user may receive a sequence of digital marketing content and thus an effect of each of the items of content in the sequence has collectively toward conversion.

Further, as conventional techniques depend on identification of positive outcomes in conversion of a product or service (e.g., a click, purchase, and so forth), these conventional techniques are not able to determine whether digital marketing content actually exhibited a negative effect on conversion. Consequently, a lack of accuracy of these conventional techniques may have an adverse effect on user interaction, an ability of a service provider to convert a product or service and thus directly affect revenue of the service provider, as well as efficiency in control of provision of digital marketing content to users.

### SUMMARY

Techniques and systems are described to estimate a causal impact of digital marketing content. A digital medium environment is configured to estimate a resulting causal impact of a particular item of digital marketing content on digital marketing outcome. Examples of digital marketing outcomes include conversion rates, subscription rates, an amount of revenue generated, and so forth.

A first sequence is identified of a plurality of items of digital marketing content provided to a first set of users taken from a plurality of users, in which the first sequence including the particular item. For example, a first sequence of digital marketing items “A,” “B”, “C”, “X,” and “D” is identified that includes the particular item “X” for which the resulting causal impact is being estimated.

A second sequence is constructed of the plurality of items of the digital marketing content by removing the particular item from the first sequence, e.g., to form a second sequence of digital marketing items “A,” “B”, “C”, and “D” that does not include the particular item “X.” A second set of users is then identified from the plurality of users, the second set of users provided with the second sequence.

A subset of users from the first set of users are then located as having a characteristic that matches a subset of users from the second set of users. Examples of characteristics include household income, gender, and so forth. Thus, these subsets describe users have matching characteristics and that have received either the first or second sequences of marketing items. A determination is then made of a first causal impact of the particular item on the digital marketing outcome for the subset of users from the first set and a second causal impact of the particular item on the digital marketing outcome for the subset of users from the second set. The resulting causal impact is estimated of the particular item of digital marketing content on the digital marketing outcome based on the first and second causal impacts. The first and second causal impacts, for instance, may be compared to determine whether the particular item of digital marketing content has a positive, neutral, or negative impact on the digital marketing outcome such as conversion rates, subscription rates, an amount of revenue generated, and so forth as based on a first set of users that received the particular item and a second set of users that did not.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1 is an illustration of an environment in an example implementation that is operable to employ causal impact estimation techniques described herein.

FIG. 2 depicts a system showing a marketing manager module and causal impact system of FIG. 1 in greater detail as processing marketing data automatically and without user intervention to determine a causal impact of a particular item of digital marketing content.

FIG. 3 illustrates an example implementation that includes a first graph as depicting a ranking of five email campaigns with revenues generated from each campaign and a second graph in which email campaigns are ranked based on casual effect thereby illustrating a negative causal impact.

FIG. 4 depicts a system in an example implementation in which a causal impact system of a marketing manager module of FIG. 1 initiates a process to estimate a causal impact of a particular item of digital marketing content.

FIG. 5 depicts a system in an example implementation in which the causal impact system of FIG. 4 continues a process to estimate a resulting causal impact of a particular item of digital marketing content.

FIG. 6 is a flow diagram depicting a procedure in an example implementation in which a resulting causal impact of digital marketing content is estimated.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

Overview

Digital marketers employ a variety of insights about activities of existing and potential consumers in order to understand the performance of digital marketing content provided to the consumers. In this way, the digital marketers may control provision of subsequent items of digital marketing content to increase a likelihood that the digital marketing content is of interest to these consumers. In one example, performance of an email campaign is often measured by conversion, which includes a number of opens, clicks, purchases, revenue generated from contributions from the email campaign, and so forth. In order to measure this performance, conventional techniques attribute outcomes from single instances of digital marketing content, e.g., a single email in this example.

However, causation of these outcomes may not be limited to this single instance of digital marketing content. For example, users typically progress through stages of a buying cycle, such as from awareness, to interest, to consideration, intent, purchase, and repurchase. A single instance of digital marketing content, however, is not likely to accurately span each of these stages. Thus, in practice the users typically receive a sequence of digital marketing content that is configured to prompt the user to move through these stages toward purchase of the good or service.

Consequently, a conventional practice of computing return on investment of a marketing campaign based on individual instances of digital marketing content is misplaced. The reason is that doing so ignores a causal impact of other items of digital marketing content in a sequence that may have been sent before or after a particular item of interest, which may have contributed at least in part to conversion observed for that particular item of digital marketing content. Accordingly, techniques used to control provision of subsequent items of digital marketing content may act erroneously and cause errors due to reliance on these conventional techniques. This may reduce efficiency in campaigns that employ the digital marketing content, reduce revenue to service providers that provide the products or services, and decrease a user's experience with these items digital marketing content.

Techniques and systems are described to estimate causal impact of digital marketing content. In one example, a resulting causal impact of digital marketing content is estimated over time in a manner that takes into account other items of digital marketing content that have been provided to users. Sequences of digital marketing content, for instance, may be identified, and outcomes associated with the digital marketing content may be compared to determine an effect of particular items of that content as part of inclusion in or absence from these sequences.

The disclosed techniques are also usable to not only determine a positive causal impact of the digital marketing content (e.g., an increase in conversion rate) but also a neutral and even negative cause effect the digital marketing content may have on other items of digital medium content. For example, a sequence of digital marketing content having a particular item may be compared with a matching sequence that does not have the particular item. In other words, the matching sequence has the particular item removed from the sequence but other items of content match which may items that match as well as a matching order of those items. This comparison may be used to determine whether inclusion of the particular item actually had an adverse effect on the conversion rate, with everything else being similar; such determination was not possible in conventional techniques that relied on individual items.

Additionally, the disclosed techniques may be configured to employ observational data by generating control and treatment groups from the data, which is readily available. For example, in email marketing campaigns, each user has elected to be part of the campaign. Thus, each user has been provided with at least one email and consequently there are no users referenced in the observational data that have not been exposed to these emails which can be considered a “pure control,” that is, without exposure to “treatment,” e.g., the email. Accordingly, in the techniques described herein “treatment” and “control” groups are defined for first and second sets of users described in the observational data, respectively, through use of the sequences and matching of characteristics of the users that are considered “clones,” as described in the following, in order to generate these groupings. In this way, observational data is employed to perform the estimation. Further discussion of these and other examples is included in the following sections.

In the following discussion, digital marketing content refers to content provided to users related to marketing activities performed, such as to increase awareness of and conversion of products or services made available by a service provider, e.g., via a web site. Accordingly, digital marketing content may take a variety of forms, such as emails, advertisements included in webpages, webpages themselves, and so forth. Causal impact refers to an effect that the digital marketing content has on conversion of the product or service, e.g., on selection, purchases, and so on. Outcome variables refer to an outcome of the causal impact being evaluated, such as on conversion, which can be, opening of emails, clicking on links within emails, purchasing etc.

An example environment is first described that may employ the estimation techniques described herein. Example procedures are then described which may be performed in the example environment as well as other environments. Consequently, performance of the example procedures is not limited to the example environment and the example environment is not limited to performance of the example procedures.

Example Environment

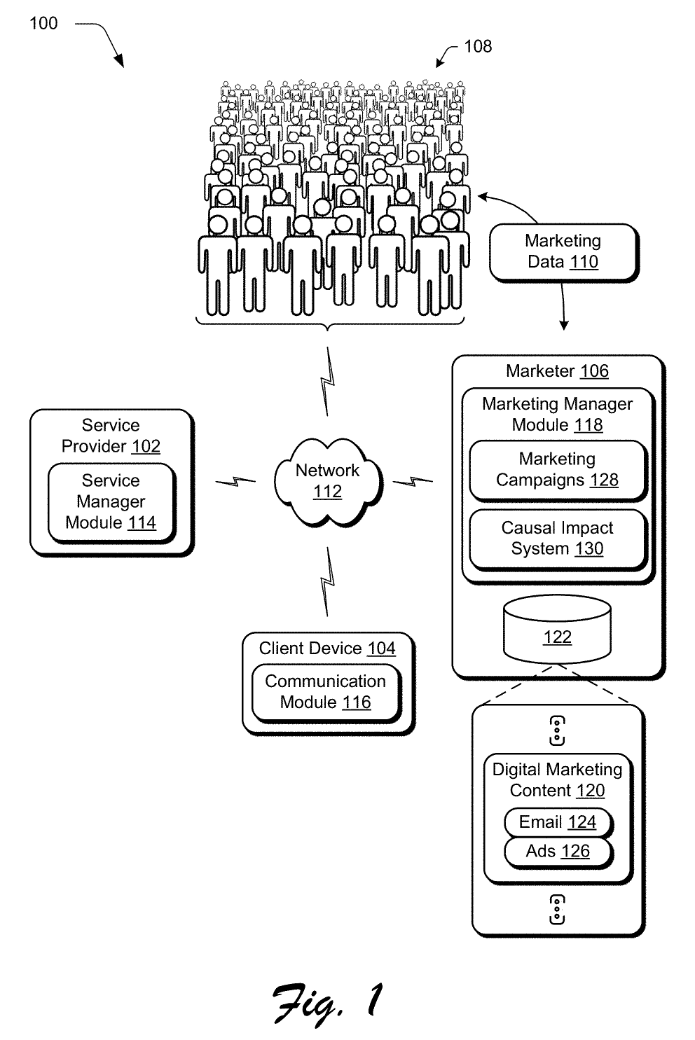

FIG. 1 is an illustration of an environment 100 in an example implementation that is operable to employ causal impact estimation techniques described herein. The illustrated environment 100 includes a service provider 102, client device 104, marketer 106, and source 108 of marketing data 110 that are communicatively coupled, one to another, via a network 112. Computing devices that are usable to implement the service provider 102, client device 104, marketer 106, and source 108 may be configured in a variety of ways.

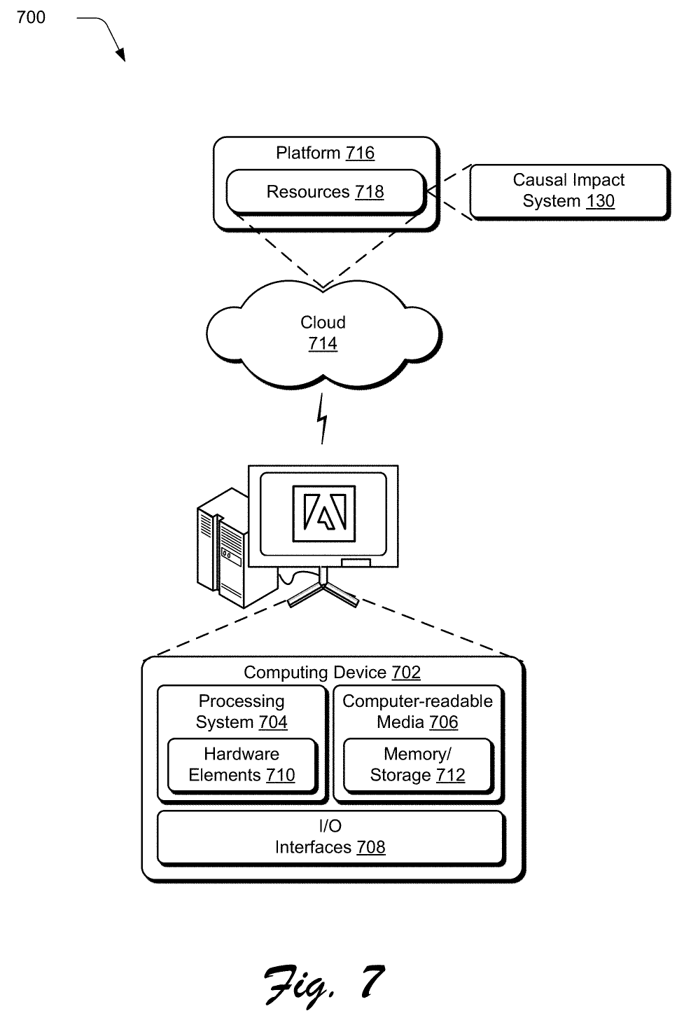

A computing device, for instance, may be configured as a desktop computer, a laptop computer, a mobile device (e.g., assuming a handheld configuration such as a tablet or mobile phone as illustrated), and so forth. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as further described in relation to FIG. 7.

The service provider 102 is illustrated as including a service manager module 114 that is representative of functionality to provide services accessible via a network 112 that are usable to make products or services available to consumers. The service manager module 114, for instance, may expose a website or other functionality that is accessible via the network 112 by a communication module 116 of the client device 104. The communication module 116, for instance, may be configured as a browser, network-enabled application, and so on that obtains data from the service provider 102 via the network 112. This data is employed by the communication module 116 to enable a user of the client device 104 to communicate with the service provider 102 to obtain information about the products or services as well as purchase the products or services.

In order to promote the products or services, the service provider 102 may employ a marketer 106. Although functionality of the marketer 106 is illustrated as separate from the service provider 102, this functionality may also be incorporated as part of the service provider 102, further divided among other entities, and so forth. The marketer 106 includes a marketing manager module 118 that is representative of functionality to provide digital marketing content 120 for consumption by users, which is illustrated as stored in storage 122, in an attempt to convert products or services of the service provider 102.

The digital marketing content 120 may assume a variety of forms, such as email 124, advertisements 126, and so forth. The digital marketing content 120, for instance, may be provided as part of a marketing campaign 128 to the sources 108 of the marketing data 110. The marketing data 110 may then be generated based on the provision of the digital marketing content 120 to describe which users received which items of digital marketing content 120 (e.g., from particular marketing campaigns) as well characteristics of the users. From this marketing data 110, the marketing manager module 118 may control which items of digital marketing content 120 are provided to a subsequent user, e.g., a user of client device 104, in order to increase a likelihood that the digital marketing content 120 is of interest to the subsequent user.

Part of the functionality usable to control provision of the digital marketing content 120 is represented as a causal impact system 130. The causal impact system 130 is representative of functionality to estimate a resulting causal impact of digital marketing content 120, e.g., on conversion of products or services of the service provider 102. The causal impact system 130, for instance, may estimate a resulting causal impact of a particular item of digital marketing content 120 over a period of time during which several items of digital marketing content 120 have been provided from marketing data 110 obtained from sources 108 (e.g., users) that received the content. Further description of which is included in the following and shown in a corresponding figure.

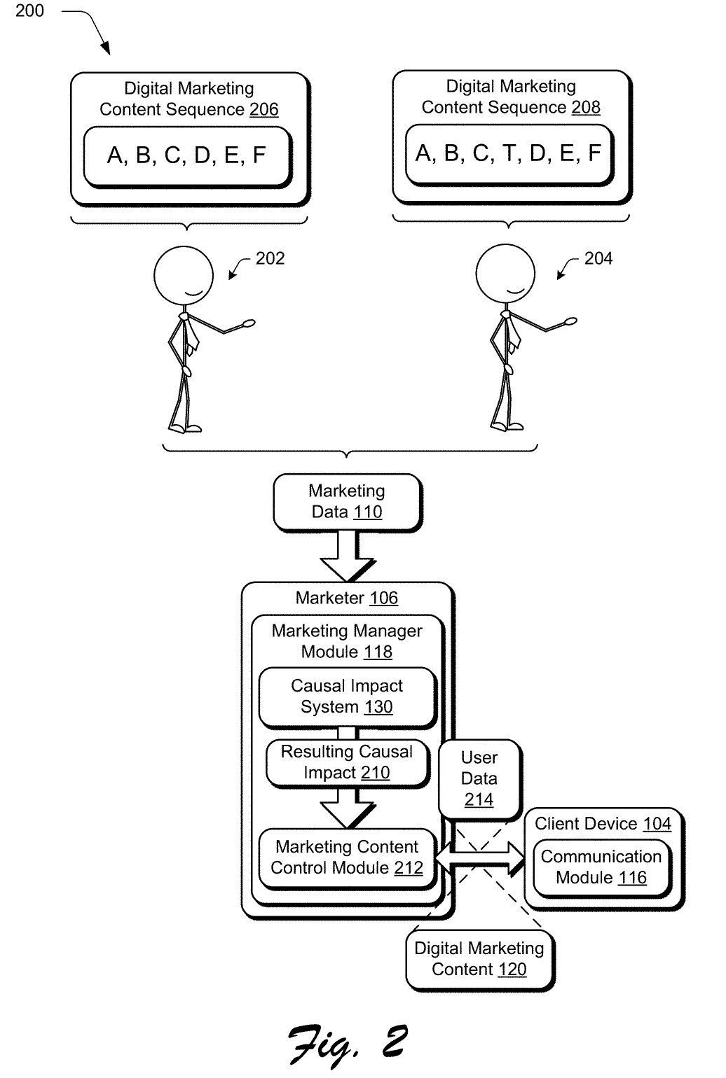

FIG. 2 depicts a system 200 showing the marketing manager module 118 and causal impact system 130 of FIG. 1 in greater detail as processing marketing data 110 automatically and without user intervention to determine a causal impact of a particular item of digital marketing content. The causal impact system 130 is configured to determine the causal impact of a particular item of digital marketing content over a predefined amount of time, e.g., fifteen days. For example, first and second users 202, 204 are illustrated as having been provided with digital marketing content sequences 206, 208. Digital marketing content sequence 206 is illustrated as having received items of digital marketing content (e.g., email) in a sequence as “A,”, “B”, “C”, “D,” “E,” and “F.” Digital marketing content sequence 208 is illustrated as having received items of digital marketing content (e.g., email) in a sequence as “A,”, “B”, “C”, “T,” “D,” “E,” and “F.” Thus, digital marketing content sequence 206 matches digital marketing content sequence 208 absent a particular item of digital marketing content “T” as described in the marketing data 110.

Through identification of the sequences, the causal impact system 130 is configured to address a resulting causal impact 210 (e.g., a total causal impact) of a marketing campaigns 128 on a digital marketing outcome such as conversion rate, revenue generation, subscription rate, and so on. The resulting causal impact 210 may be described for a digital marketing outcome in a variety of ways, such as a difference in value of an outcome variable of interest (e.g., revenue generated, conversion rate, un-subscription rate, and so on) that the marketer 106 would have observed if the marketing campaign under consideration was not conducted (e.g., involving the particular item of digital marketing content “T”) while keeping other potentially influencing factors constant.

In order to do so, the causal impact system 130 is configured to identify a first set of users as a control the digital marketing content sequence 208 including the particular item “T” as a treatment group. The causal impact system 130 is also configured to identify a second set of users (e.g., user 202) that have received a matching digital marketing content sequence 206 that does not include the particular item “T” as a control group. Thus, as illustrated, the causal impact system 130 is configured to consider both sequences to consider digital marketing items that have been received before and/or after the particular item of digital marketing content in question. Additionally, for each particular item of digital marketing content “T”, there may be multiple sequences having various lengths that are considered by the causal impact system 130 to estimate the resulting causal impact 210 as further described below.

The causal impact system 130, through identification of the treatment and control groups as described above, is able to employ observational data is the calculation of the resulting causal impact 210 even in instances in which each user described in the marketing data 110 has received an item of digital marketing content and thus no “pure control” is available as used on conventional techniques. For example, in the case of an email campaign, each of the users has typically opted-in to receive emails and thus none of the users described in the marketing data 110 have not received an email. Conventional techniques, however, typically employ “pure” control groups in which users in the control groups have not received the “treatment,” e.g., the email, and thus are not usable in such scenarios. Through definition of the control and treatment groups by the causal impact system 130 as described above, however, observational marketing data 110 is still usable to determine the resulting causal impact 210.

Additionally, with certain types of digital marketing content 120 such as email campaigns described in marketing data 110, there is a proportion of the digital marketing content 120, with which, interaction has occurred and thus is considered a positive outcome, e.g., opened, clicked, result in conversion, and so forth. Conventional metrics typically rely on this positive outcome in order to determine and quantify a causal impact that is positive and thus cannot determine a possible negative effect of a particular item of digital marketing content on a desired digital marketing outcome. In the techniques described herein, however, a possible negative effect of a particular item of digital marketing content 120 is also revealed, which can occur due to interaction with other items of digital marketing content in a sequence. For instance, this may be observed when for a specified period of time inclusion of the particular item of digital marketing content 120 results in fewer conversions in the treatment group (i.e., the first set of users that have received the item) than in the control group, i.e., the second set of users that have not received the item. This comparison may leverage identification of “clones” of users between the groups that have similar characteristics, such as income, age, and so on as further described below.

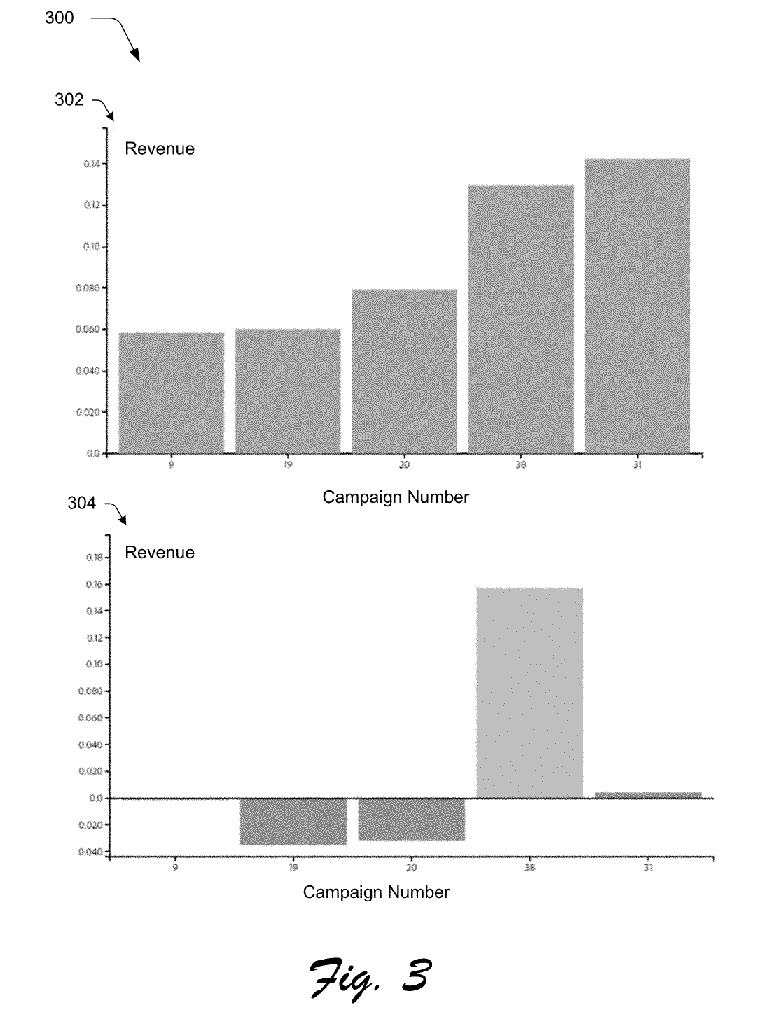

As illustrated in the example implementation 300 of FIG. 3, for instance, a first graph 302 depicts a ranking of five email campaigns with revenues generated from each campaign. In the second graph 304, the email campaigns are ranked based on casual effect, which illustrate that those occurring below the line actually had a negative effect and thus should not have been provided for consumption by respective users.

The estimation of the resulting causal impact 210 may be employed to support a variety of functionality. An example of this is illustrated as a marketing content control module 212 that is representative of functionality to control which items of digital marketing content 120 are provided to subsequent users, illustrated as client device 104. User data 214, for instance, may be obtained that identifies characteristics of the user and digital marketing content 120 may be provided based on those characteristics and the estimation of resulting causal impact 210. In another example, the digital marketing content 120 is provided based on which items of digital marketing content 120 were already provided to the client device 104 and based on the resulting causal impact 210 to determine which other item of digital marketing content is to then be provided. A variety of other examples of control are described in the following.

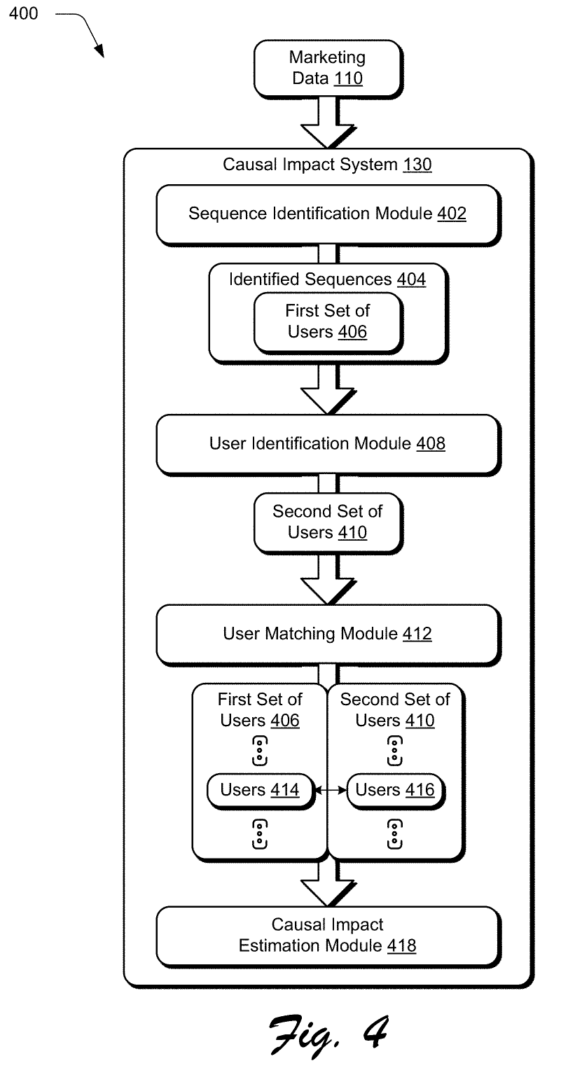

FIG. 4 depicts a system 400 in an example implementation in which the causal impact system 130 of the marketing manager module 118 of FIG. 1 initiates a process to estimate a resulting causal impact 210 of a particular item of digital marketing content. The causal impact system 130 is configured to estimate the resulting causal impact 210 of a particular item of digital marketing content (e.g., as part of a marketing campaign 128) over a period of time in which a user receives a sequence of digital marketing content, e.g., emails. The causal impact system 130 may be implemented in a variety of ways, such as through use of one or more computing devices having modules implemented at least partially in hardware as described in the following.

The causal impact system 130, for instance, may rank items of digital marketing content based on outcome variables (e.g., interaction such as open rates or click rates, monetary considerations such as revenue, and so forth) and is not limited to positive outcomes as described above. For example, the causal impact system 130 may identify redundant and even negative impacts on the outcome variables over the period of time as described in the following.

In the following, a technique is described them employs propensity scoring with observational data. As previously described, in some situations users elect to receive digital marketing content 120 (e.g., email) and thus observational data that describes these situations is limited to description of users that have received the content. In other words, this means all of the users described in the marketing data 110 have received at least one item of the digital marketing content 120 and thus a “pure” control group is not available as employed in conventional techniques. In this context, the causal impact system 130 is configured to form first and second sets of users as “treatment” and “control” groups in order to employ observational data to estimate the resulting causal impact 210.

To begin, the causal impact system 130 receives the marketing data 110, such as from the service provider 102, collected by the marketer 106 based on which items of digital marketing content 120 are sent to which users in the source 108, and so forth. A sequence identification module 402 is then employed that is representative of functionality to identify sequences 404 in the marketing data 110 that include a particular item of digital marketing content, for which, the resulting causal impact 210 is to be estimated, e.g., particular digital marketing content “T” in the following. The sequence identification module 402, for instance, may be implemented at least partially in hardware as logic to identify a sequence as configured using a processor and memory, an integrated circuit configured according to this logic, and so forth. From this, a first set of users 406 (i.e., a treatment group) is identified from the marketing data 110 that have received the identified sequences 404.

A user identification module 408 is them employed, which is representative of functionality to identify a second set of users 410 that have also received the identified sequences 404, but absent the particular digital marketing content “T.” The user identification module 408, for instance, may be implemented at least partially in hardware as logic to identify users as configured using a processor and memory, an integrated circuit configured according to this logic, and so forth. As previously described in relation to FIG. 2, for instance, digital marketing content sequence 208 is illustrated as having received items of digital marketing content (e.g., email) in a sequence as “A,”, “B”, “C”, “T,” “D,” “E,” and “F” and thus includes the particular item of digital marketing content “T.” Digital marketing content sequence 206 is recognized as a sequence as “A,”, “B”, “C”, “D,” “E,” and “F” and thus matches digital marketing content sequence 208 absent the particular item of digital marketing content “T.” Accordingly, digital marketing content sequence 208 represents a treatment group that has received the treatment (e.g., particular item of digital marketing content “T”) and digital marketing content sequence 206 represents a control group that has not received this treatment.

In order to estimate the resulting causal impact 210, information is used from the treatment and control groups of users who are similar to each other, e.g., in characteristics from set “s.” Functionality usable to perform this matching is represented by a user matching module 412 in which users 414 from the first set of users 406 (i.e., the treatment group having received “T”) are matched to users 416 in the second set of users 410, i.e., the control group that did not receive “T.” The user matching module 412, for instance, may be implemented at least partially in hardware as logic to locate users as configured using a processor and memory, an integrated circuit configured according to this logic, and so forth as further described in the following.

The user matching module 412 may employ a set of covariates that describe characteristics of the users that are usable to match them, one to another. Examples of covariates include household income, gender, time since start of receive a particular marketing campaign 128, average order value of past in-store purchases, average order value of past online purchases (e.g., from the service provider 102), number of past purchases, average fit size, and so forth.

The propensity of a user to actually receive the treatment “T,” given the covariates may be expressed as follows:

e=P(T−1/X)

where “T=1” for a consumer that receives the particular item of digital marketing content being evaluated, and “0” otherwise. A propensity score, which lies between “0” and “1” acts as a summary measure for the covariates. This propensity may be calculated in a variety of ways, such as by using a logical regression with each of the users, in both the first and second sets of users 406, 410 (i.e., the treatment and control groups), for each of the identified sequences 404.

Two users 414, 416 having similar propensity scores are also referred to as “clones” in the following. The user matching module 412 is configured to employ a variety of different technique to perform this matching. In one example, a greedy algorithm for nearest neighbor matching is used based on propensity score. This matches each of the users 414 from the first set of users 406 that have received the “treatment” to users 416 from the second set of users 410 that have not, i.e., the control group. In this way, pairs are formed of the users 414, 416 between the first and second sets 406 410.

The pairs of users 414, 416, one receiving the “treatment” (e.g., the particular item of digital marketing content “T”) in the second set of users 410 and the other not, are used by the causal impact estimation module 416 to estimate the resulting causal impact 210 through comparison of users having similar characteristics as well as having received similar sequences of items of digital marketing content. The causal impact estimation module 416, for instance, may be implemented at least partially in hardware as logic to estimate a causal impact as configured using a processor and memory, an integrated circuit configured according to this logic, and so forth as further described in the following. An example of such estimation is described in the following and shown in a corresponding figure.

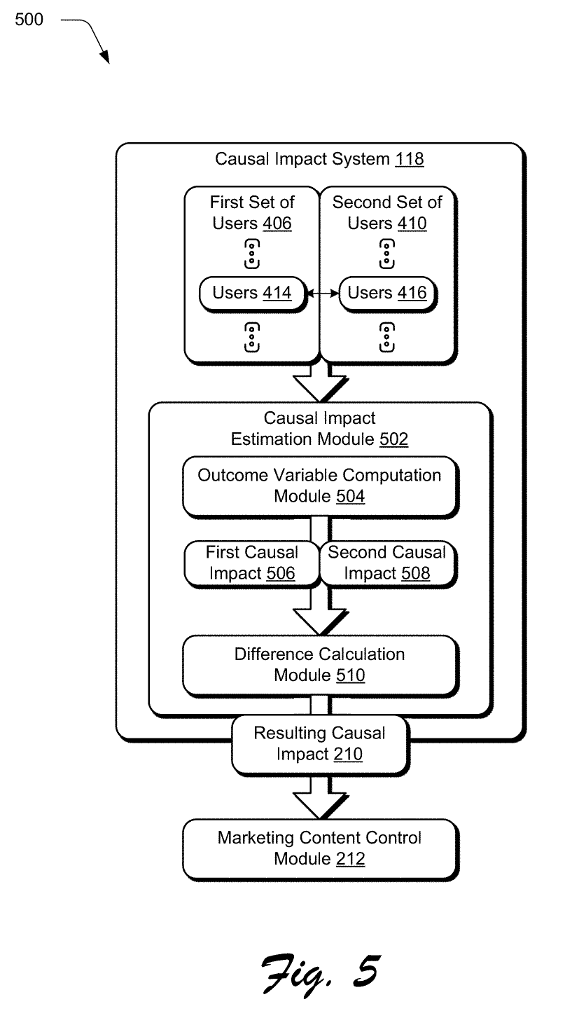

FIG. 5 depicts a system 500 in an example implementation in which the causal impact system 130 continues a process initiated in FIG. 4 to estimate a resulting causal impact 210 of a particular item of digital marketing content. The causal impact system 118 is illustrated as including a causal impact estimation module 502 that is representative of functionality to estimate the resulting causal impact 210 from the paired users in the first and second sets 406, 410 of FIG. 4. As above, causal impact estimation module 402, for instance, may be implemented at least partially in hardware as logic to estimate a causal impact as configured using a processor and memory, an integrated circuit configured according to this logic, and so forth as further described in the following. This estimation is performable in a variety of ways.

The causal impact estimation module 502 is illustrated in this instance as employing an outcome variable computation module 504 that is representative of functionality implemented at least partially in hardware to impute a first causal impact 506 to at least one outcome variable for users 414 in the first set of users 406 that have been matched to users 416 in the second set of users 410. Likewise, the outcome variable computation module 504 is also used to impute a second causal impact 508 for users 416 in the second set of users 410 that have been matched to users 414 in the first set of users 406. In other words, the outcome variable computing module 504 imputes initial causal impacts (e.g., the first and second causal impacts 506, 508) to a digital marketing outcome for the paired users that are similar, one to another.

The outcome variable computation module 504 may impute the first and second causal impacts 506, 508 in a variety of ways. In one example, a regression module is fit with a propensity score and covariates, e.g., prior total purchase order value, prior total number of clicks, prior total number of emails opened, demographics, and so forth. A logarithm of the outcome variable is taken as a dependent variable “Y” in the regression model as shown in the following expression.

Y=log(1+Outcome Variable)

A logarithm is chosen in this example to address an observation that a number of positive outcomes (e.g., email opens, proportion of selections, proportion of purchases, revenue generated) is relatively low in comparison with negative outcomes.

The first causal impact 506 is determined (e.g., imputed) by the outcome variable computation module 504 among the first set of users 406 (i.e., the treatment group) as if the users were actually controls. Thus, the above regression model is first fit with those users who are the matched controls “T=0.” Then, the unobserved outcome variables “Yₜ(0)” for the treated group are estimated by scoring the fitted model of the control as if the first set of users 406 (i.e., the treated group) had been controls in reality, with the covariates of the first set of users 406 that are matched, i.e., the matched treated users.

Thus, the first causal impact 506 of the particular item of digital marketing content “T” on the first set of users 406 (i.e., the treated group) is estimated as follows:

Iₜ=E(Yₜ(1))−(E(Yₜ(0))

The second causal impact 508 of the particular item of digital marketing content on the control group (i.e., the second set of users 410) is then estimated through use of a similar model as follows:

=E(Y_{c}(1))−(E(Y_{c}(0))

An impact comparison module 510 implemented at least partially in hardware as logic to estimate a resulting causal impact as configured using a processor and memory, an integrated circuit configured according to this logic, and so forth. The impact comparison module 510 is configured to calculate the resulting estimated causal impact 210 of the particular item of digital marketing content “T” as a whole based on a comparison the first and second causal impacts 506, 508. In one example, the comparison is calculated as a difference between the first and second causal impacts 506, 508 on the first and second sets of users 406, 410 (i.e., the treatment and control groups) as follows:

I=(exp(Iₜ)+exp(I_{c}))/2−1

Thus, in this example the resulting causal impact 210 for the particular item of digital medium content as a whole on a digital marketing outcome (e.g., conversion) is calculated based on the causal impacts imputed for the first and second sets of users, i.e., the treatment and control groups.

In the previous example, a single sequence was identified and processed for the sake of simplicity of the discussion. However, the causal impact system 130 is configured to support processing of a variety of sequences in conjunction (e.g., simultaneously) in order to estimate the resulting causal impact 210. For example, an intermediary causal impact may be generated for first and second users for different sequences that are then combined to form the resulting causal impact 210. Additionally, pairs of users (e.g., clones) in the above may be divided into subclasses such that each of the users in one subclass have similar distribution of covariates for treatment and control such that intermediary causal impacts for these subclasses are aggregated into the resulting impact for the particular item of digital marketing content across all users described in the marketing data 110. A variety of other examples are also contemplated as further described in relation to the following procedure.

Example Procedures

The following discussion describes causal impact techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

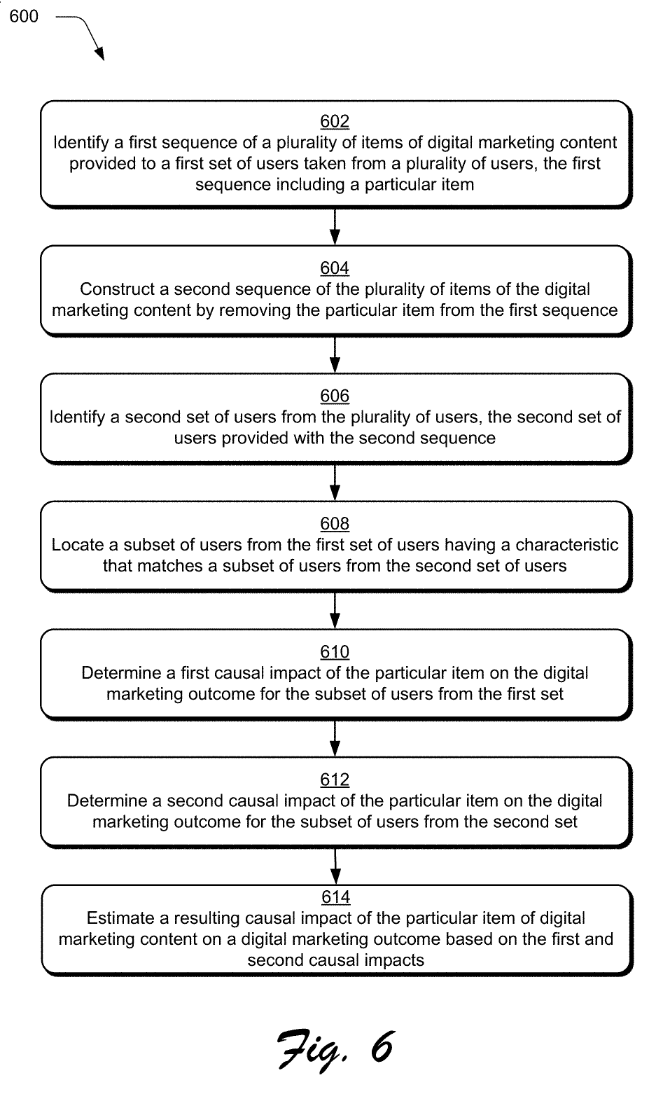

FIG. 6 depicts a procedure 600 in an example implementation in which a resulting causal impact of digital marketing content is estimated. A digital medium environment is configured to estimate a resulting causal impact of a particular item of digital marketing content on conversion of a product or service. To begin, a first sequence is identified of a plurality of items of digital marketing content provided to a first set of users taken from a plurality of users, the first sequence including the particular item (block 602). A sequence of items “A,” “B”, “C”, “X,” and “D” of digital marketing content, for instance may be identified that includes a particular item “X.”

Then, a second sequence is constructed of the plurality of items of the digital marketing content by removing the particular item from the first sequence (block 604), such as by removing the particular item “X” from the first sequence to form a second sequence having matching items arranged in a matching order of “A,” “B”, “C”, and “D.” A second set of users are identified from the plurality of users, the second set of users provided with the second sequence (block 606). Thus, the constructed second sequence is used to locate a second set of users that have received a second sequence of items of digital marketing content that matches a first sequence of items of digital marketing content but for the particular item of content.

A subset of users is then located from the first set of users having a characteristic that matches a subset of users from the second set of users (block 608). In this way, the characteristic is used to form subsets of users having the similar characteristic from the first and second sets. A variety of characteristics may be used, such as any of household income, gender, amount of time in which respective users received at least one of the plurality of items of digital marketing content, amount of money spent on purchases of goods or services related to the plurality of items of digital marketing content, or number of purchases of goods or services related to the plurality of items of digital marketing content.

The resulting casual impact is then estimated from these subsets. For example, a determination is made as to a first causal impact of the particular item on the digital marketing outcome for the subset of users from the first set (block 610) and in this way defines the causal impact on a “treatment group” that received the particular item of digital marketing content. A determination is also made of a second causal impact of the particular item on the digital marketing outcome for the subset of users from the second set (block 612) and in this way defines the causal impact on a “control group” that did not receive the particular item of digital marketing content.

The resulting causal impact is then estimated of the particular item of digital marketing content on the digital marketing outcome based on the first and second causal impacts (block 614), such as by subtracting the second causal impact of the “control group” from the first causal impact of the “treatment group” that did receive the particular item of digital marketing content. In this way, the resulting causal impact may be used to identify a positive, neutral, and even negative causal impact of the particular item of digital marketing content on a digital marketing outcome through comparison of an effect exhibited by the particular item on groups that did and did not receive the item. A variety of other examples are also contemplated as described above.

Example System and Device

FIG. 7 illustrates an example system generally at 700 that includes an example computing device 702 that is representative of one or more computing systems and/or devices that may implement the various techniques described herein. This is illustrated through inclusion of the causal impact system 130. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to estimate a resulting causal impact of a particular item of digital marketing content on a digital marketing outcome, a method implemented by a computing device, the method comprising:
identifying, by the computing device, a first sequence of a plurality of items of digital marketing content provided to a first set of users taken from a plurality of users, the first sequence including the particular item;
constructing, by the computing device, a second sequence of the plurality of items of the digital marketing content by removing the particular item from the first sequence;
identifying, by the computing device, a second set of users from the plurality of users, the second set of users provided with the second sequence;
locating, by the computing device, a subset of users from the first set of users having a characteristic that matches a subset of users from the second set of users;
determining, by the computing, a first causal impact of the particular item on the digital marketing outcome for the subset of the users from the first set;
determining, by the computing, a second causal impact of the particular item on the digital marketing outcome for the subset of the users from the second set; and
estimating, by the computing device, the resulting causal impact of the particular item of digital marketing content on the digital marketing outcome based on the first and second causal impacts.

2. The method as described in claim 1, wherein the plurality of users is described using observational data in which each of the plurality of users are provided with at least one of the plurality of items of digital marketing content.

3. The method as described in claim 1, wherein the locating includes calculating a propensity score as a summary measure for the characteristic for respective said users in the first and second sets.

4. The method as described in claim 3, wherein the characteristic includes any of household income, gender, amount of time in which the respective said users received at least one of the plurality of items of digital marketing content, amount of money spent on purchases of goods or services related to the plurality of items of digital marketing content, or number of purchases of goods or services related to the plurality of items of digital marketing content.

5. The method as described in claim 3, wherein the locating includes using a greedy algorithm to locate the subset of users from the first set of users having the characteristic that matches the subset of users from the second set of users.

6. The method as described in claim 1, wherein the digital marketing outcome includes any of a conversion rate, an amount of revenue generated, or a subscription rate caused by the particular item of the digital marketing content for a corresponding good or service.

7. The method as described in claim 1, wherein the resulting causal impact indicates whether the particular item of the digital marketing content has a positive, neutral, or negative causal impact on the digital marketing outcome.

8. The method as described in claim 1, wherein the estimating of the resulting causal impact includes subtracting the first causal impact from the second causal impact.

9. In a digital medium environment to estimate a positive, neutral, or negative causal impact of a particular item of digital marketing content on a digital marketing outcome, a method implemented by a computing device, the method comprising:
identifying, by the computing device, a first sequence of a plurality of items of digital marketing content provided to a first set of users taken from a plurality of users, the first sequence including the particular item;
constructing, by the computing device, a second sequence of the plurality of items of the digital marketing content by removing the particular item from the first sequence;
identifying, by the computing device, a second set of users from the plurality of users, the second set of users provided with the second sequence;
locating, by the computing device, a subset of users from the first set of users having a characteristic that matches a subset of users from the second set of users;
determining, by the computing, a first causal impact of the particular item on the digital marketing outcome for the subset of the users from the first set;
determining, by the computing, a second causal impact of the particular item on the digital marketing outcome for the subset of the users from the second set; and
estimating, by the computing device, whether the particular item of the digital marketing content has the positive, neutral, or negative causal impact on the digital marketing outcome based on a comparison of the first causal impact to the second causal impact.

10. The method as described in claim 9, wherein the plurality of users is described using observational data in which each of the plurality of users are provided with at least one of the plurality of items of digital marketing content.

11. The method as described in claim 9, wherein the locating includes calculating a propensity score as a summary measure for the characteristic for respective said users in the first and second sets.

12. The method as described in claim 11, wherein the characteristic includes any of household income, gender, amount of time in which the respective said users received at least one of the plurality of items of digital marketing content, amount of money spent on purchases of goods or services related to the plurality of items of digital marketing content, or number of purchases of goods or services related to the plurality of items of digital marketing content.

13. The method as described in claim 9, wherein the digital marketing outcome includes a conversion rate, an amount of revenue generated, or a subscription rate for the particular item of the digital marketing content.

14. In a digital medium environment to estimate a resulting causal impact of a particular item of digital marketing content on a digital marketing outcome, a system comprising:
a sequence identification module implemented at least partially in hardware to:
identify a first sequence of a plurality of items of digital marketing content provided to a first set of users taken from a plurality of users, the first sequence including the particular item;
construct a second sequence of the plurality of items of the digital marketing content by removing the particular item from the first sequence; and
identify a second set of users from the plurality of users, the second set of users provided with the second sequence;
a user matching module implemented at least partially in hardware to locate a subset of users from the first set of users having a characteristic that matches a subset of users from the second set of users; and
a causal impact estimation module implemented at least partially in hardware to estimate the resulting causal impact based on a comparison of a first causal impact of the particular item on the digital marketing outcome for the subset of users from the first set and a second causal impact of the particular item on the digital marketing outcome for the subset of users from the second set.

15. The system as described in claim 14, wherein the plurality of users is described using observational data in which each of the plurality of users are provided with at least one of the plurality of items of digital marketing content.

16. The system as described in claim 14, wherein user matching module is configured perform the matching by calculating a propensity score as a summary measure for the characteristic for respective said users in the first and second sets.

17. The system as described in claim 14, wherein user matching module is configured to locate the subset of users from the first set of users having the characteristic that matches the subset of users from the second set of users by using a greedy algorithm.

18. The system as described in claim 14, wherein the digital marketing outcome includes a conversion rate, an amount of revenue generated, or a subscription rate for the particular item of the digital marketing content on a good or service associated with the particular item.

19. The system as described in claim 14, wherein the resulting causal impact indicates whether the particular item of the digital marketing content has a positive, neutral, or negative causal impact on the digital marketing outcome.

20. The system as described in claim 14, wherein causal impact estimation module is configured to estimate of the resulting causal impact by subtracting the first causal impact from the second causal impact.
